(19) United States
(12) Patent Application Publication
(10) Pub. No.: US 2014/0279815 A1
(43) Pub. Date: Sep. 18, 2014

(54) System and Method for Generating Greedy Reason Codes for Computer Models

(71) Applicant: Opera Solutions, LLC, Jersey City, NJ (US)

(72) Inventors: Weiqiang Wang, San Diego, CA (US); Lujia Chen, Shanghai (CN); Chengwei Huang, Shanghai (CN); Lu Ye, Hagzhou (CN); Yonghui Chen, San Diego, CA (US)

(73) Assignee: OPERA SOLUTIONS, LLC, Jersey City, NJ (US)

(21) Appl. No.: 14/208,945

(22) Filed: Mar. 13, 2014

Related U.S. Application Data
(60) Provisional application No. 61/784,116, filed on Mar. 14, 2013.

(51) Int. Cl. G06N 5/04

(52) U.S. Cl. CPC G06N 5/04
USPC 706/52

(57) ABSTRACT

A system and method for generating greedy reason codes for computer models is provided. The system for generating greedy reason codes for computer models, comprising a computer system for receiving and processing a computer model of a set of data, said computer model having at least one record scored by the model, and a greedy reason code generation engine stored on the computer system which, when executed by the computer system, causes the computer system to identify reason code variables that explain why a record of the model is scored high by the model, and build an approximate model to simulate a likelihood of a high score being generated by at least one of the reason code variables identified by the engine.

### CROSS-REFERENCE TO RELATED APPLICATION

This application claims priority to U.S. Provisional Patent Application No. 61/784,116 filed on Mar. 14, 2013, which is incorporated herein by reference in its entirety.

### BACKGROUND

1. Field of the Disclosure

The present disclosure relates to a system and method for generating greedy reason codes for computer models.

2. Related Art

Currently, for big data applications, clients typically require high performance models, which are usually advanced complex models. In business (e.g., consumer finance and risk, health care, and marketing research), there are many non-linear modeling approaches (e.g., neural network, gradient boosting tree, ensemble model, etc.). At the same time high score reason codes are often required for business reasons. One example is in the fraud detection area where neural network models are used for scoring, and reason codes are provided for investigation.

In many applications of machine learning modeling techniques, including practices of consumer finance and risk, as well as marketing, more advanced complexity models are desired to meet client requirements of high model performance. At the same time, clients often require a good explanation for the output of these models, specifically for high scores, which is challenging to obtain. These challenges include incorporating the effects of interrelationships between raw variables, and generating a reason code in real time in a production environment. To satisfy all constraints, many existing solutions use simple linear models, which sacrifices performance compared to complex models.

There are different techniques to provide reason codes for non-linear complex models in the big data industry. Existing solutions for generating reason codes for complexity models (such as Neural Networks) leverage sensitivity analysis by using partial-derivatives of the model with each input variable, which implies an independency between each input variable when the effect of each variable is pre-calculated by fixing the remaining variables to the global mean (which requires knowing the explicit form of the model). Subsequently, the sensitivity analysis method (or a similar method) could be modified by approximating the partial derivatives through binning each input variable and checking the deviation of the score while assuming every other input variable has the population mean value. However, the population mean value also loses track of the interaction between input variables.

### SUMMARY

By identifying reason codes for the advanced scoring model offline, and approximating them in a Gaussian Missing Data Model (GMDM) model, reason codes are provided for a high performance model in real time. The system and method of the present disclosure includes a two-step approach to identify the reason codes for high score output in real time production. The reason codes are identified for training data for a given advanced high performance scoring model by using a greedy searching algorithm. The reason codes are generated in real time in production for high score output from complex models by using a multi-labeling classification model trained based on the training data with identified reason codes.

The system for generating greedy reason codes for computer models, comprising a computer system for receiving and processing a computer model of a set of data, said computer model having at least one record scored by the model, and a greedy reason code generation engine stored on the computer system which, when executed by the computer system, causes the computer system to identify reason code variables that explain why a record of the model is scored high by the model, and build an approximate model to simulate a likelihood of a high score being generated by at least one of the reason code variables identified by the engine.

### BRIEF DESCRIPTION OF THE DRAWINGS

The foregoing features of the disclosure will be apparent from the following Detailed Description, taken in connection with the accompanying drawings, in which:

FIG. 1 is a diagram illustrating the system of the present disclosure;

FIG. 2 illustrates processing steps of the system of the present disclosure;

FIG. 3 illustrates processing steps of the system of the present disclosure;

FIG. 4 is a graph illustrating the ROC curve of the GMDM that was used to identify the top three reason code variables for the testing data set; and

FIG. 5 is a diagram showing hardware and software components of the system.

### DETAILED DESCRIPTION

The present disclosure relates to systems and methods for generating greedy reason codes for computer models, as discussed in detail below in connection with FIGS. 1-5. The system and method provide a solution for challenges in production by training a Gaussian Mixture model based on defining identified reason codes of training data using a greedy searching algorithm. The trained model provides a way of explaining the high score of a transaction for the scoring model in real time. This system can be used as a new approach or packaged into an individual product for model deployment in production to provide reason codes for any advanced models deployed. The system and method is applicable to any convex complex scoring model. By the term “greedy reason code,” it is meant a reason code which provides the best primitive reason for a given data set being modeled.

FIG. 1 is a diagram showing a system for generating greedy reason codes for computer models, indicated generally at 10. The system 10 comprises a computer system 12 (e.g., a server) having a database 14 stored therein and greedy reason code generation engine 16. The computer system 12 could be any suitable computer server (e.g., a server with an INTEL microprocessor, multiple processors, multiple processing cores) running any suitable operating system (e.g., Windows by Microsoft, Linux, etc.). The database 14 could be stored on the computer system 12, or located externally (e.g., in a separate database server in communication with the system 10).

The system 10 could be web-based and remotely accessible such that the system 10 communicates through a network 20 with one or more of a variety of computer systems 22 (e.g., personal computer system 26a, a smart cellular telephone 26b, a tablet computer 26c, or other devices). Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format.

FIG. 2 illustrates processing steps 50 of the system of the present disclosure. The system utilizes a two-step approach to identify up to three reason codes that can explain why a record is scored high by a complex model in production. The first step 52 is to identify the reason code variables that can explain synergistically why the score is high. A greedy search algorithm is used to identify the reason code variables that causes the largest score drop. This is a greedy method and it is difficult to apply in production since it is very expensive in computation. As a result, a second step is introduced to model the reasons generated in the first step. The second step 54 is to build an approximate model to simulate in real time the likelihood of each input variable causing a high score. The Gaussian Missing Data Model (GMDM) is used as the classification model to predict the likelihood of the input variables making up the reason code.

FIG. 3 illustrates processing steps 60 of the system of the present disclosure. For identifying reason codes, the number of reason code variables is a predefined adjustable input parameter. These reason code variables are selected using a greedy system (algorithm) consisting of the following steps. The first step 62 of the system is a “backward phase,” where for each interested record, the differences between its original score and the scores without any one of input variables are computed. In step 64, the input variable that produces the maximum drop when it is removed is the most significant variable, and defined as a “backward variable.” The next step 66 is a “forward phase,” where each interested record is scored again by keeping only the selected “backward variable” and one of the other input variables. In step 68, the input variable associated with the highest forward phase score is defined as the “forward variable” and contributes most significantly together with the “backward variable.” In step 70, a determination is made if stopping criteria are met. If so, the process proceeds to step 72. If not, steps 66 and 68, are repeated until a stopping criterion is met (e.g., either the total number of input variables is equal to the predefined number or the score contributed by the selected variables is above a certain threshold). The next step 72 combines these identified “backward variable” and “forward variables” into the reason codes and calculates the total contribution they made to the original score in the same way as was done in the “backward phase.”

A GMDM model is used for predicting reason codes. The above processing steps can be very time consuming if the input model's complexity is high. In this step, to utilize the approach in production at real time, a multi-label classification model is built to simulate identified reason codes with input variables. By assuming that product rating vectors from users are independent and identically distributed (iid), GMDM predicts the missing ratings by maximizing the likelihood of the conditional mean. As an example, records could include the input variable and the likelihood of each variable as the reason code can be considered as iid. Given the input variable values, the likelihood of each input variable can be scored as the reason code. Details of model parameter estimation can be found in W. Robert, “Application of a Gaussian, missing-data model to product recommendation,” IEEE Signal Processing Letters, 17(5):509-512, 2010, the entire disclosure of which is incorporated herein by reference.

As an example, GMDM could be used in a recommender system that predicts preferences of users for products. Consider a recommender system involving n users and k products. An observed rating is a rating given by one of the users to one of the products. Any rating not observed is a missing rating. The total number of observed and missing ratings is nk. The product recommendation problem is to predict missing ratings. Other applications for recommender systems include social networking, dating sites, and movie recommendations.

In the recommender systems, the ratings from each user are assumed k-dimensional Gaussian random vectors. The k-dimensional vectors from different users are assumed to be independent and identically distributed (iid). The common mean and covariance are estimated from the observed ratings. Due to desirable asymptotic properties (large datasets with large n and k are common in real applications) maximum likelihood (ML) estimation is used for this estimation. An explicit ML estimate of the mean is readily known. The ML estimate of the covariance in this recommender system has no known explicit form and here is a modified stochastic gradient descent algorithm. For more information, see D. W. McMichael, “Estimating Gaussian mixture models from data with missing features,” in Proc. 4th Int. Symp. Sig. Proc. And its Apps., Gold Coast, Australia, August 1996, pp. 377-378, the entire disclosure of which his incorporated herein by reference. Given estimates of the mean and covariance, minimum mean squared error (MMSE) prediction of the missing ratings is performed using the conditional mean.

In the case of greedy reason code predictions, the reason codes for the testing data are literally the missing ratings for the corresponding testing data records. ML estimate of the covariance is obtained from training data, and the missing ratings (here the reason codes) of the testing data are predicted using MMSE.

The greedy reason code system (algorithm) of the present disclosure can identify the same reasons as a traditional method in a linear model. In one example, the first step of the disclosed approach with logistic regression model was tested. This example shows that by utilizing the system and method of the present disclosure the complex model converges smoothly when applied to the simple linear model. Here, a logistic regression model was trained on a client data, where 4,000 out of 1,000,000 transaction records were selected as high score records from a trained 3^{rd} party logistic regression model. The top three reason codes for each of these 4,000 high score records were generated using conventional reason code generation methodology for the logistic regression model. The greedy reason code identification system was then applied by taking the logistic model as input and then generated three reason codes for each of the 4,000 high score records. Comparison between the generated top three reason codes and the top three reason codes generated using the conventional method for logistic regression model match exactly, which supports the robustness of the approach. Table 1 shows that the match rate (number of reason codes identified by the greedy method and traditional method at the same time/number of reason codes identified by the traditional method) is 100% for all of the top three reason code variables.

TABLE 1

| | Reason Code Var-1 | Reason Code Var-2 | Reason Code Var-3 |
|---|---|---|---|
| Match | 100% | 100% | 100% |
| rate | | | |

FIG. 4 is a graph illustrating the receiver operating characteristic (ROC) curve of the GMDM that was used to identify the top three reason code variables for the testing data set. In this test example, the system identified greedy reason codes based on the output from a Neural Network (NNet) Model developed for a real world solution. Here, the Neural Network Model was trained with one hidden layer and two hidden nodes, with 30 input nodes and one output nodes. The activation function was a non-linear sigmoid function. This model was considered to highly incorporate the inter-correlation between input variables, and the performance was about 5-10% better than a linear logistic regression model. For the top 5,000 highest scored records from the output of the NNet model, the reason code identification algorithm of the system was first applied to identify the reason code variables for each record. Then they were split into two populations: training (3,500 records) and testing (1,500 records). Next, the GMDM model was trained on the training data, and its performance was tested on the testing data. The results show that over 80˜90% of the reason code variables were accurately predicted by simply scoring them using the trained model. The following plot shows the ROC curve of the GMDM that was used to identify the top three reason code variables for the testing data. The performance of the model (auc=0.9357) proves the feasibility of the GMDM model for identifying the reason codes for testing data. Scoring a transaction using the GMDM model is essentially the same computational time as scoring the transaction using the input NNet model.

FIG. 5 is a diagram showing hardware and software components of a computer system 100 on which the system of the present disclosure could be implemented. The system 100 comprises a processing server 102 which could include a storage device 104, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 102 could be a networked computer system, a personal computer, a smart phone, tablet computer etc. It is noted that the server 102 need not be a networked server, and indeed, could be a stand-alone computer system.

The functionality provided by the present disclosure could be provided by a greedy reason code generation program/engine 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single- or multiple-core microprocessor of any suitable architecture that is capable of implementing and running the greedy reason code generation program 106 (e.g., Intel processor). The random access memory 114 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected is set forth in the following claims.

What is claimed is:

1. A system for generating greedy reason codes for computer models, comprising:
a computer system for receiving and processing a computer model of a set of data, said computer model having at least one record scored by the model; and
a greedy reason code generation engine stored on the computer system which, when executed by the computer system, causes the computer system to:
identify reason code variables that explain why a record of the model is scored high by the model; and
build an approximate model to simulate a likelihood of a high score being generated by at least one of the reason code variables identified by the engine.

2. The system of claim 1, wherein the greedy reason code generation engine, when executed by the computer system, further causes the computer system to:
compute for each of a plurality of input variables a difference between an original score and a score without the input variable;
identify a first input variable that causes a maximum score drop when removed, and defining the first input variable as a backward variable;
score each record by keeping only the backward variable and each of the other input variables;
identify a second input variable associated with a highest score, and defining the second input variable as a forward variable;
combine the backward variable and the forward variable into a reason code; and
calculate total contribution of the reason code by computing a difference between an original score and a score without the reason code.

3. The system of claim 2, wherein a plurality of forward variables are identified and defined until a stopping criterion is met.

4. The system of claim 3, wherein the stopping criterion is when a total number of input variables is equal to a predefined number.

5. The system of claim 3, wherein the stopping criterion is when a score contributed by the backward variable and forward variables is above a threshold.

6. The system of claim 1, wherein the approximate model is a Gaussian Missing Data Model.

7. A method for generating greedy reason codes for computer models comprising:
receiving and processing, by a computer system, a computer model of a set of data, said computer model having at least one record scored by the model;
identifying, by a greedy reason code generation engine stored on and executed by the computer system, reason code variables that explain why a record of the model is scored high by the model; and
building by the greedy reason code generation engine an approximate model to simulate a likelihood of a high score being generated by at least one of the reason code variables identified by the engine.

8. The method of claim 7, further comprising:
computing for each of a plurality of input variables a difference between an original score and a score without the input variable;
identifying a first input variable that causes a maximum score drop when removed, and defining the first input variable as a backward variable;
scoring each record by keeping only the backward variable and each of the other input variables;
identifying a second input variable associated with a highest score, and defining the second input variable as a forward variable;
combining the backward variable and the forward variable into a reason code; and
calculating total contribution of the reason code by computing a difference between an original score and a score without the reason code.

9. The method of claim 8, wherein a plurality of forward variables are identified and defined until a stopping criterion is met.

10. The method of claim 8, wherein the stopping criterion is when a total number of input variables is equal to a predefined number.

11. The method of claim 8, wherein the stopping criterion is when a score contributed by the backward variable and forward variables is above a threshold.

12. The method of claim 7, wherein the approximate model is a Gaussian Missing Data Model.

13. A non-transitory computer-readable medium having computer-readable instructions stored thereon which, when executed by a computer system, cause the computer system to perform the steps of:
receiving and processing, by the computer system, a computer model of a set of data, said computer model having at least one record scored by the model;
identifying, by a greedy reason code generation engine stored on and executed by the computer system, reason code variables that explain why a record of the model is scored high by the model; and
building by the greedy reason code generation engine an approximate model to simulate a likelihood of a high score being generated by at least one of the reason code variables identified by the engine.

14. The computer-readable medium of claim 13, further comprising:
computing for each of a plurality of input variables a difference between an original score and a score without the input variable;
identifying a first input variable that causes a maximum score drop when removed, and defining the first input variable as a backward variable;
scoring each record by keeping only the backward variable and each of the other input variables;
identifying a second input variable associated with a highest score, and defining the second input variable as a forward variable;
combining the backward variable and the forward variable into a reason code; and
calculating total contribution of the reason code by computing a difference between an original score and a score without the reason code.

15. The computer-readable medium of claim 14, wherein a plurality of forward variables are identified and defined until a stopping criterion is met.

16. The computer-readable medium of claim 14, wherein the stopping criterion is when a total number of input variables is equal to a predefined number.

17. The computer-readable medium of claim 14, wherein the stopping criterion is when a score contributed by the backward variable and forward variables is above a threshold.

18. The computer-readable medium of claim 13, wherein the approximate model is a Gaussian Missing Data Model.
